(19) United States
(12) Patent Application Publication
(10) Pub. No.: US 2008/0196367 A1
(43) Pub. Date: Aug. 21, 2008

(54) METHOD AND APPARATUS FOR DETECTING AND REMOVING AIRBORNE IMPURITIES WITHIN AN ENCLOSED CHAMBER

(75) Inventors: Frank Ventorina Ryder, Metairie, LA (US); Shane Perry Cohen, Potomac, MD (US)

Correspondence Address: THE OLLILA LAW GROUP LLC, 2060 BROADWAY, SUITE 300, BOULDER, CO, 80302, US

(73) Assignee: Oreck Holdings, LLC, Cheyenne, WY (US)

(21) Appl. No.: 11/676,431

(22) Filed: Feb. 19, 2007

(51) Int. Cl. B01D 46/00; B01D 50/00; G01N 7/00

(52) U.S. Cl. 55/385.2; 95/8

(57) ABSTRACT

An apparatus for detecting and removing airborne impurities within an enclosed chamber is provided according to an embodiment of the invention. The enclosed chamber includes a chamber housing and an opening in the chamber housing for introducing airborne impurities. The enclosed chamber also includes a meter for detecting the airborne impurity level within the enclosed chamber. At least one air cleaner located within the chamber housing is provided for removal of airborne impurities.

### TECHNICAL FIELD

The present invention relates to air cleaners, and more particularly, to a chamber including an air cleaner that is designed to detect and remove airborne impurities.

### BACKGROUND OF THE INVENTION

Due to increasing pollution levels many people have turned to air cleaners as a way to increase the quality of air they breathe, at least within the home or office. Air cleaners are devices that remove impurities from the air. Common types of impurities can include smoke, dust, pollen and other allergens, pet hair and pet dander, airborne mold and bacteria, volatile organic compounds (VOCs), and other gases, contaminants and odors, etc. They are often used by persons suffering from allergies or persons who are sensitive to impurities. They are used by persons in settings where impurities are at higher than normal levels. They are used by persons for medical reasons, such as to avoid infection and/or irritation of the respiratory system. They are used by persons having respiratory problems.

Before purchasing an air cleaner, a customer may want to know how well it performs. For example, a customer may want to know how well impurities are removed from the surrounding environment. One type of impurity of particular interest are VOCs. Because they come from a variety of common sources such as household cleaners, paint, air fresheners, cosmetics, and aerosol products, for example, they are common in the home and office. VOCs can cause a variety of health problems, such as nausea, dizziness, eye, respiratory tract, and mucous membrane irritation, headache, and fatigue, for example. VOCs are especially troublesome to persons with allergies, asthma, or persons with a suppressed immune system. Therefore, one of the main reasons for purchasing an air cleaner is the desire to remove these harmful impurities from the surrounding environment.

A difficulty exists, however, in evaluating how well a particular air cleaner removes impurities before purchasing. This is because many of these impurities are invisible to the naked eye. Even if the air cleaner is turned on, the potential customer has no way of determining how well the air cleaner is removing impurities, such as VOCs. There exists a need for a way to determine the efficiency of an air cleaner in removing impurities that a potential customer is unable to see.

### SUMMARY OF THE INVENTION

An apparatus for detecting and removing airborne impurities within an enclosed chamber is provided according to an embodiment of the invention. The apparatus comprises a chamber housing and an opening in the chamber housing for introducing airborne impurities. The apparatus further comprises a meter for detecting airborne impurities within the chamber housing. The apparatus also includes an air cleaner located within the chamber housing for removal of the airborne impurities.

A method for detecting and removing airborne impurities within an enclosed chamber is provided according to an embodiment of the invention. The method comprises providing a chamber housing with an opening in the chamber housing for introducing airborne impurities. The method further comprises providing a meter for detecting airborne impurities within the chamber housing. The method also comprises providing at least one air cleaner located within the chamber housing for removal of airborne impurities.

A method for detecting and removing airborne impurities within an enclosed chamber is provided according to an embodiment of the invention. The method comprises introducing airborne impurities into a chamber housing. The method further comprises operating at least one air cleaner within the chamber housing and providing a visual representation of the airborne impurity level within the chamber housing.

### BRIEF DESCRIPTION OF THE DRAWINGS

FIG. 1 shows an enclosed chamber and a meter according to an embodiment of the invention.

FIG. 2 shows a routine for detecting and removing airborne impurities according to an embodiment of the invention.

FIG. 3 shows another routine for detecting and removing airborne impurities according to an embodiment of the invention.

### DETAILED DESCRIPTION OF THE INVENTION

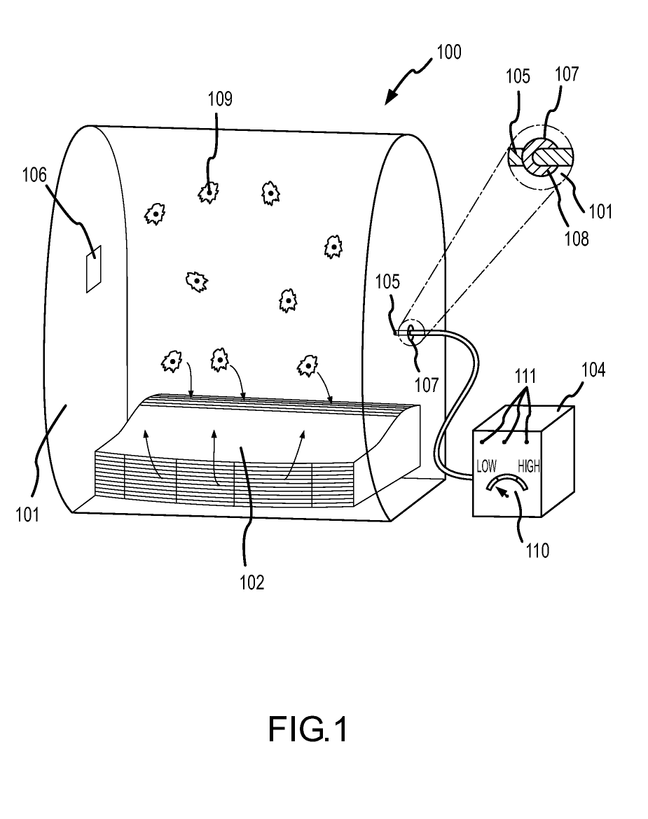

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a chamber 100 and a meter 104 according to an embodiment of the invention. Chamber 100 includes a substantially air-tight chamber housing 101, at least one air cleaner 102, a probe 105, a probe aperture 107, and an opening 106.

Chamber 100 allows a potential customer an opportunity to monitor how efficient a particular air cleaner is at removing airborne impurities from the surrounding environment. It should be understood that “airborne impurities” is meant to include an inferior component in the air desired to be removed. Chamber 100 provides a way to both detect and remove impurities from the air within the chamber housing 101. Many of the impurities that are detected and removed are substantially invisible and therefore without chamber 100 a potential customer would have no way of determining how efficient a particular air cleaner is at removing these invisible impurities. The chamber housing 101 is preferably substantially transparent to demonstrate that the air cleaner 102 is removing substances that are invisible. However, the chamber housing 101 does not have to be transparent.

Located within the chamber housing 101 is at least one air cleaner 102. The air cleaner 102 can be inserted into the chamber housing 101 through a door (not shown) in the chamber housing 101, for example. According to an embodiment of the invention, the chamber housing 101 could dismantle to allow the insertion of the air cleaner 102. According to another embodiment of the invention, the air cleaner 102 could sit on a table or other surface and the chamber housing 101 could be placed on top of the air cleaner 102. In this embodiment, the surface that the air cleaner 102 sits on would provide the base of the chamber housing 101.

The chamber housing 101 could also include a small aperture or electrical fixture (not shown) to allow power to be supplied to the air cleaner 102. Alternatively, if the air cleaner 102 is supplied with battery power, the chamber housing 101 does not have to be supplied with a small aperture or electrical fixture. The air cleaner 102 is shown located completely inside of the chamber housing 101. It should be understood however, that the air cleaner 102 does not have to be completely inside of the chamber housing 101. The chamber housing 101 could provide ducting or passages for air to flow from within the chamber housing 101, trough the air cleaner 102, and back into the chamber housing 101, for example. The air cleaner 102 removes airborne impurities from the air within the chamber housing 101, such as the airborne impurities 109. In a preferred embodiment, the airborne impurities 109 can include some amount of VOCs, for example.

Under normal operating conditions, the airborne impurities 109 can be visible, invisible, or a mix. The airborne impurities 109 are shown in FIG. 1 for illustrative purposes and should in no way limit the scope of the present invention.

The airborne impurities 109 can be introduced into chamber 100 through the opening 106 in the chamber housing 101, for example. According to one embodiment, the opening 106 has a door or other closure member (not shown) that can seal the opening 106. The airborne impurities 109 introduced into the chamber housing 101 can come from a variety of sources including from a household cleaner, for example. However, the airborne impurities 109 can be introduced from any source which disperses airborne impurities into the air.

Once introduced, the airborne impurities 109 can be removed from the air in the chamber 100 by the air cleaner 102. According to an embodiment of the invention, the air cleaner 102 uses an electrostatic precipitator cell and a catalytic matrix to remove VOCs and other airborne impurities. It should be understood however, that the air cleaner 102 can be any cleaner that is capable of removing impurities from the surrounding environment.

According to an embodiment of the invention, a meter 104 is included to detect the airborne impurities 109 within the chamber housing 101. In a preferred embodiment, the meter 104 is a VOC meter capable of measuring the level of VOCs in the air. The meter 104 could be any VOC meter generally known in the art, such as for example, the RI VOC Meter provided by Research Instruments, Ltd., which can be found at www.Research-instruments.com, or the 2020 ppbPro VOC meter provided by Photovac, Inc., which can be found at www.photovac.com. The precise meter used is not important for the purposes of the present invention and therefore, should not limit the scope of the present invention. It should also be understood that the meter 104 does not have to be a VOC meter. The meter 104 can be any meter capable of measuring an airborne impurity level or levels.

According to one embodiment, the meter 104 displays an arbitrary scale ranging from a “high” level of airborne impurity to a “low” level of airborne impurity. This arbitrary scale can be predetermined and can be calibrated to whatever scale and/or unit is desired. The meter 104 can also be calibrated to signal when the airborne impurity has reached a high level. According to one embodiment, the meter 104 can signal a high level using a dial, such as dial 10, LED lights, such as LEDs 111, a combination thereof or any manner of visual and/or audible indication.

According to an embodiment of the invention, chamber 100 can include a probe 105. In this embodiment, a first end of the probe 105 is connected to the meter 104 and a second end of the probe is coupled to the chamber housing. According to an embodiment, the second end of the probe is inserted into the chamber housing 101 through a probe aperture 107. The probe aperture 107 can include a seal 108. The seal 108 can be an O-ring, for example. However, the seal 108 can be any type of seal generally known in the art that would provide a substantially air-tight seal between the probe 105 and the probe aperture 107. While it is not necessary to include the seal 108, the seal 108 is provided for a more accurate reading of the airborne impurity level within the chamber housing 101. Alternatively, the probe 105 could be formed as a part of the chamber housing 101. In this embodiment, both the probe aperture 107 and the seal 108 could be omitted.

In the embodiments described above, the probe 105 transfers a signal to the meter 104, which then measures the airborne impurity level within the chamber housing 101. However, the probe 105 could be omitted and the meter 104 could be located directly inside of the chamber housing 101. In this embodiment, the meter 104 could include a sensor or sensors to detect the airborne impurity level or levels within the chamber housing 101. It should be understood that the meter can include any type of indicator and need not be a sensor. The indicator could include a reactive indicator such as litmus paper, for example. The precise indicator used should not limit the scope of the invention.

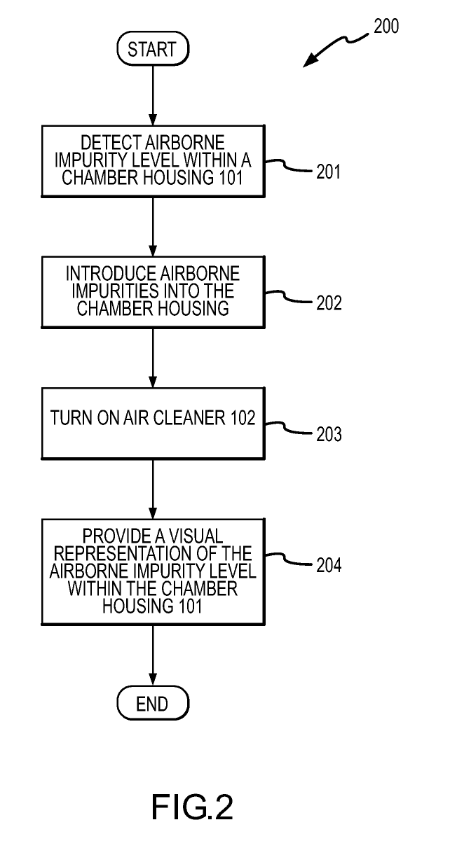

FIG. 2 shows a routine for detecting and removing airborne impurities according to an embodiment of the invention. According to one embodiment of the invention, routine 200 describes how airborne impurities are detected and removed from the air within the chamber housing 101. Routine 200 could be used in relation to the detection and removal of VOCs from the air within the chamber housing 101. The use of VOCs as the airborne impurity demonstrates that the air cleaner 102 is capable of removing toxic impurities such as VOCs and that the air cleaner 102 is more than a simple dust cleaner. It should be understood however, that routine 200 could be used in relation to any type of airborne impurity.

The start of routine 200 can be initiated manually, or alternatively could be set to an automatic cycle. In step 201, the airborne impurity level within the chamber housing 101 is detected. According to an embodiment of the invention, the meter 104, which in a preferred embodiment is a VOC meter, detects the airborne impurity level within the chamber housing 101. The meter 104 can detect this level either by the use of the probe 105, which is connected to the meter 104 at a first end and coupled to the chamber housing 101 at a second end, or if the meter 104 is located within the chamber housing 101, the probe 105 can be omitted. Although not required, in a preferred embodiment, the airborne impurity level within the chamber housing 101 is at a low level. This could be accomplished by turning on the air cleaner 102 prior to the start of routine 200, for example. According to an embodiment of the invention, the meter 104 can continue to detect the airborne impurity level within the chamber housing 101 throughout routine 200.

In step 202, airborne impurities are introduced into the chamber housing 101. Preferably, airborne impurities are introduced through the opening 106 in the chamber housing 101. According to one embodiment, the opening 106 has a door, or other closure member (not shown) that can seal the opening 106. The airborne impurities introduced into the chamber housing 101 can come from a variety of sources including from a household cleaner, for example. However, the airborne impurities can be introduced from any source which disperses airborne impurities into the air. The airborne impurities could contain some amount of VOCs; however, the airborne impurities do not have to contain VOCs.

In step 203, the air cleaner 102 is turned on. The air cleaner 102 removes dangerous airborne impurities such as VOCs, along with other toxic chemicals from the air inside of the chamber housing 101. In one embodiment, routine 200 does not proceed to step 203 until the airborne impurity level has reached a high level. Once the air cleaner 102 is turned on, the air cleaner 102 begins removing airborne impurities and the airborne impurity level will drop.

In step 204, the meter 104 provides a visual and/or audible representation of the airborne impurity level within the chamber housing 101. In one embodiment, this representation is a substantially real time airborne impurity level. According to another embodiment, the representation could be a substantially average airborne impurity level.

The meter 104 preferably displays the airborne impurity level using dial 110, LEDs 111, a combination thereof, or any other visual signal to identify the airborne impurity level. The meter 104 could also send a signal to a computer monitor or other type of monitor to display the airborne impurity level. The meter 104 could also use an audible signal to identify the airborne impurity level, such as an audible alarm when the airborne impurity level reaches a high level or an alarm for a duration of a high level, for example. Step 204 can continue until the user ends routine 200. Step 204 could also end when the meter 104 detects that the airborne impurity level has returned to a low level.

While routine 200 has been described as detecting the airborne impurity level before introducing the airborne impurities, in other embodiments, the airborne impurity level is not detected until after the airborne impurities are introduced. As a consequence, the specific order of the steps provided should not limit the scope of the invention.

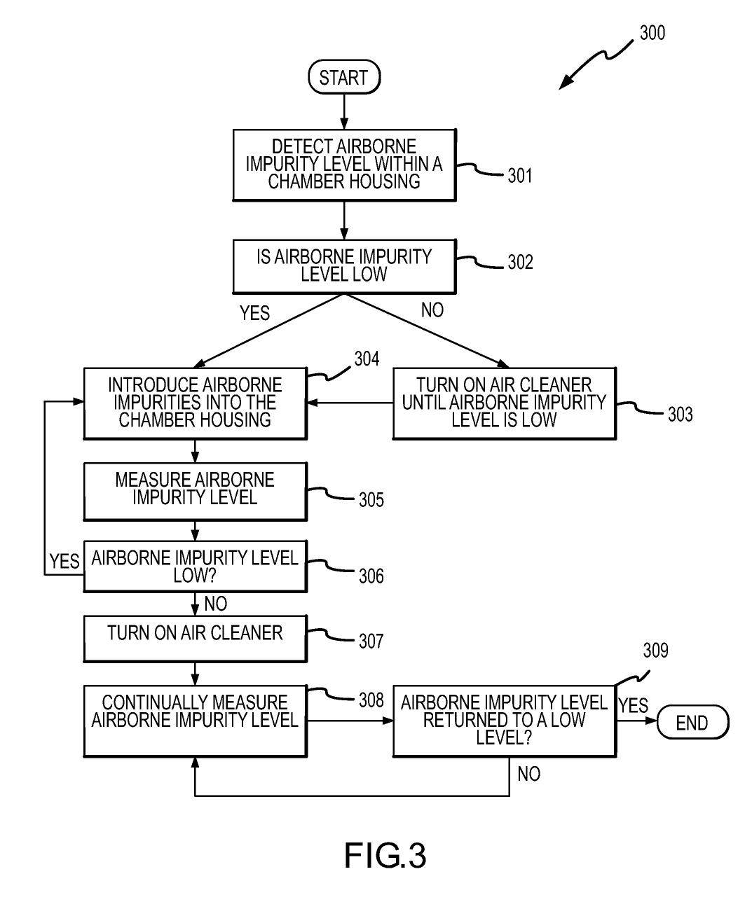

FIG. 3 shows another routine for detecting and removing airborne impurities according to an embodiment of the invention. The start of routine 300 can be initiated manually, or alternatively could be set to an automatic cycle, as previously discussed.

In step 301, the airborne impurity level within the chamber housing 101 is detected. The airborne impurity level could be detected with the meter 104, for example. The meter 104 can detect this level using the probe 105, or alternatively, the meter 104 could be located within the chamber housing 101 and the probe 105 could be omitted.

In step 302, the meter 104 determines if the airborne impurity level within the chamber housing 101 is safe. If the airborne impurity level is safe, routine 300 continues on to step 304. If the airborne impurity level is not safe, routine 300 branches to step 303.

In step 303, the air cleaner 102 is turned on until the airborne impurity level has returned to a low level. Once the airborne impurity level has returned to a low level, the air cleaner 102 is turned off and routine 300 continues to step 304.

In step 304, airborne impurities are introduced into the chamber housing 101, as previously discussed. The airborne impurities can contain some amount of VOCs, as previously discussed.

In step 305, the airborne impurity level is measured, preferably with the meter 104.

In step 306, the meter 104 determines if the airborne impurity level has reached a high level. If the airborne impurity level is still at a low level, routine 300 branches back to step 304 in order to introduce additional airborne impurities. The airborne impurity level is again measured and if the airborne impurity level has reached a high level, routine 300 proceeds on to step 307.

In step 307, the air cleaner 102 is turned on. Once the air cleaner 102 is turned on, the air cleaner 102 begins removing airborne impurities from the air within the chamber housing 101.

In step 308, the meter 104 measures the airborne impurity level within the chamber housing 101. The meter 104 can substantially continuously measure the airborne impurity level. As the air cleaner 102 removes airborne impurities, the airborne impurity level will drop.

In step 309, the airborne impurity level is continually measured until it has returned to a low level. Once step 309 determines the airborne impurity level has returned to a low level, routine 300 ends.

Routines 200 and 300 have been described as a way to both detect and remove airborne impurities from the air within the chamber housing 101. The routines also provide a way for a potential customer to observe the time taken to remove airborne impurities from the surrounding air. The two routines could also be used to show the rate of airborne impurity removal. Additionally, routines 200 and 300, and chamber 100 in general, could just as easily be used in the laboratory to test the efficiency of an air cleaner. For example, chamber 100 could be used during the development stages of designing an air cleaner. Routines 200 and 300 are examples of ways to monitor the efficiency of an air cleaner in removing airborne impurities. Equivalent routines are contemplated and are within the scope of the present invention.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other air cleaners and chambers, and not just to the embodiments described above and shown in the accompanying figures. Accordingly, the scope of the invention should be determined from the following claims.

We claim:

1. An apparatus for detecting and removing airborne impurities within an enclosed chamber, comprising:
a chamber housing;
an opening in the chamber housing for introducing airborne impurities;
a meter for detecting airborne impurities within the chamber housing; and
at least one air cleaner located within the chamber housing for removal of airborne impurities.

2. The apparatus of claim 1, wherein the airborne impurities contain at least some amount of volatile organic compounds (VOCs).

3. The apparatus of claim 1, wherein the meter is a VOC meter.

4. The apparatus of claim 1, further comprising a probe connected to the meter at a first end and coupled to the chamber housing at a second end.

5. The apparatus of claim 4, further comprising a probe aperture in the chamber housing.

6. The apparatus of claim 5, wherein the probe aperture further comprises a sealing means which provides a substantially air-tight seal between the probe and the probe aperture.

7. The apparatus of claim 1, wherein the meter for detecting airborne impurities is located within the chamber housing.

8. The apparatus of claim 1, wherein the chamber housing is substantially transparent.

9. A method for detecting and removing airborne impurities within an enclosed chamber, comprising:
providing a chamber housing;
providing an opening in the chamber housing for introducing airborne impurities;
providing a meter for detecting airborne impurities within the chamber housing; and
providing at least one air cleaner located within the chamber housing for removal of airborne impurities.

10. The method of claim 9, wherein the airborne impurities contain at least some amount of VOCs.

11. The method of claim 9, wherein the meter is a VOC meter.

12. The method of claim 9, further comprising connecting a probe to the meter at a first end and coupling the probe to the chamber housing at a second end.

13. The method of claim 12, further providing a probe aperture in the chamber housing.

14. The method of claim 13, further comprising inserting at least a portion of the probe into the probe aperture wherein, the probe aperture is provided with a sealing means which creates a substantially air-tight seal between the probe and the probe aperture.

15. The method of claim 9, wherein the meter for detecting airborne impurities is located within the chamber housing.

16. The method of claim 9, wherein providing a chamber housing comprises providing a substantially transparent chamber housing.

17. A method for detecting and removing airborne impurities within an enclosed chamber, the method comprising:
introducing airborne impurities into a chamber housing;
operating at least one air cleaner within the chamber housing; and
providing a visual representation of the airborne impurity level within the chamber housing.

18. The method of claim 17, wherein the airborne impurities contain at least some amount of VOCs.

19. The method of claim 17, wherein providing a visual representation of the airborne impurity level within the chamber housing comprises the steps of:
detecting an airborne impurity level with a meter; and
displaying a substantially real time airborne impurity level condition within the chamber housing.

20. The method of claim 17, wherein providing a visual representation of the airborne impurity level within the chamber housing comprises the steps of:
detecting an initial and a final airborne impurity level with the meter; and
displaying a substantially average airborne impurity level condition within the chamber housing.

21. The method of claim 19 or claim 20, wherein the meter is a VOC meter.

22. The method of claim 17, wherein the air cleaner is operated after the meter detects a high level of airborne impurities within the chamber housing.
